(19) United States
(12) Patent Application Publication
(10) Pub. No.: US 2009/0317019 A1
(43) Pub. Date: Dec. 24, 2009

(54) PLACEMENT OF ADVERTISEMENTS ON ELECTRONIC DOCUMENTS CONTAINING IMAGES

(76) Inventor: Venkatesh Rangarajan Puliur, San Diego, CA (US)

Correspondence Address: VENKATESH RANGARAJAN PULIUR, 10555 CAMINITO ALVAREZ, SAN DIEGO, CA, 92126, US

(21) Appl. No.: 12/142,008

(22) Filed: Jun. 19, 2008

(51) Int. Cl. G06K 9/32; G06Q 30/00

(52) U.S. Cl. 382/294

(57) ABSTRACT

Overlaying advertisement on optimum images in electronic documents to be displayed on the internet, wherein the electronic document includes at least one image. Image parameters associated with the at least one image in the electronic document are processed to obtain an optimum image, and the advertisement is overlaid on the optimum image, such that it overlaps with the optimum image. The optimum image may be determined by an image recognition engine based on at least one object in the image identified by the image recognition engine, or based on object information obtained from a tagging module. The advertisement may refer to the object. The advertisement may be selected based on contextual information associated with the electronic document. The advertisement may be any of a graphic, a video, and a text.

### BACKGROUND

1. Technical Field

The embodiments herein generally relate to internet advertising, and, more particularly to, placement of advertisements on electronic documents containing images.

2. Description of the Related Art

Internet advertising is a paid communication in which the sponsor is identified and the message is controlled. Advertisements are usually placed anywhere an audience can easily and/or frequently access visuals and/or print. Internet offers a potentially powerful way to advertise and has made an attempt to maximize the value of such internet advertising. There are companies that have pioneered mechanisms for placing advertisements. These advertisements are delivered to specified locations in a web document, which is accessed via an Internet Browser. But the advertisements are restricted to insertion of advertisements on documents interlaced with text. The location and the nature of the advertisements are pre-determined and the advertisements will always appear on a particular location on the electronic document.

With the advent of cheap digital cameras and other sharing services, a large amount of content that is being generated and published on the Internet is also in the form of images. For example, there are blogs with photographs of celebrities, concerts etc. Also, there are websites that are only for storing, sharing, and displaying photos. These websites are able to attract a lot of viewers (e.g., eyeballs), however there is no effective mechanism to leverage the number of hits to the website.

### SUMMARY

In view of the foregoing, an embodiment herein provides a method of overlaying an advertisement on an optimum image in an electronic document to be displayed on the internet, the electronic document including at least one image. The method includes processing image parameters associated with at least one image in the electronic document to obtain the optimum image, and overlaying the advertisement on the optimum image. The advertisement overlaps with the optimum image. The optimum image may be determined by an image recognition engine based on at least one object in the image identified by the image recognition engine.

In addition, the optimum image may also be determined based on object information obtained from a tagging module. The advertisement may refer to the object. The advertisement may be selected based on contextual information associated with the electronic document. The advertisement may include any of a graphic, a video, and a text. The advertisement may appear in response to a user action. An opacity of the advertisement is based on a background color of the optimum image. The advertisement may be overlaid on the optimum image based on at least one of a size of the optimum image, a location of the optimum image in the electronic document, and a user configuration.

In another aspect, a method of placing a contextual advertisement obtained from a database of advertisements on an electronic document to be displayed on the internet is provided. The electronic document includes at least one image. The image includes at least one object. The method includes processing object information associated with the object of the image to obtain an object identifier, and matching the object with the database of advertisements based on the object identifier to obtain the contextual advertisement. The contextual advertisement is rendered on the electronic document.

The object information may be automatically generated by an image recognition engine based on at least one characteristic of the image. The object identifier may be obtained from a database populated by a tagging module. The contextual advertisement may be interlaced with the image so as to overlap with the image. The contextual advertisement may refer to the object.

In yet another aspect, a method of determining a contextual advertisement obtained from a database of advertisements to be overlaid on an optimum image in an electronic document to be displayed on the internet is provided. The electronic document includes at least one image. The image includes at least one object. The method includes processing object information associated with the object, and determining the contextual advertisement based on the object information. The object information is obtained from a tagging module. The optimum image is determined based on the object information. The contextual advertisement is overlaid on the optimum image. The contextual advertisement refers to the object.

The contextual advertisement may include any of a graphic, a video, and a text. The contextual advertisement may be selected based on contextual information associated with the electronic document. The contextual advertisement may appear in response to a user action. An opacity of the contextual advertisement is based on a background color of the image. The contextual advertisement may be overlaid based on any of a size of the image, a location of the image in the electronic document, and a user configuration.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of an advertisement server communicating with a publisher server and users through a network according to an embodiment herein;

FIG. 2 illustrates an exploded view of the advertisement server of FIG. 1 having a database, an identification module, an image recognition module, a tagging module, an advertisement generation module, an advertisement selection module, a control module, an overlay module, and a targeted advertisement delivery module according to an embodiment herein;

FIG. 3 is a user interface view of the electronic document of the database of the publisher server of FIG. 1 illustrating the advertisements overlaid on the images having a first image, a second image, a third image, a first advertisement, a second advertisement, and other contents according to an embodiment herein;

FIG. 4 illustrates a table view of a database of the tagging module of FIG. 2 having an image name field, an object information field, and an object identifier field according to an embodiment herein;

FIG. 5A illustrates a user interface view of the electronic document of the database of the publisher server of FIG. 1 of overlaying the advertisement on the images by the publisher having a add a note option, options, a object, an image, an object, an object identifier, a section, and an a call out box according to an embodiment herein;

FIG. 5B is user interface views of the electronic document of the database of the publisher server of FIG. 1 of overlaid advertisements on the images as viewed by the user according to an embodiment herein;

FIG. 5C illustrates a user interface view of the electronic document having images, objects, and call out boxes according to an embodiment herein;

FIG. 6A-6B is a flow diagram illustrating a method of rendering advertisements on the images in the electronic document of the database of the publisher server of FIG. 1 according to an embodiment herein;

FIG. 7 is a flow diagram illustrating a method of generating instructions to generate and overlay advertisements on the images in the electronic document of the database of the publisher server of FIG. 1 according to an embodiment herein;

FIG. 8 is a flow diagram illustrating a method of image analysis for rendering advertisements on the images in the electronic document of the database of the publisher server of FIG. 1 according to an embodiment herein;

FIG. 9 is a flow diagram illustrating a method of storing contextual information in the database of the publisher server of FIG. 1, according to an embodiment herein;

FIG. 10 is a flow diagram illustrating a method of rendering the advertisement on the image according to an embodiment herein; and

FIG. 11 illustrates a schematic diagram of a computer architecture used in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

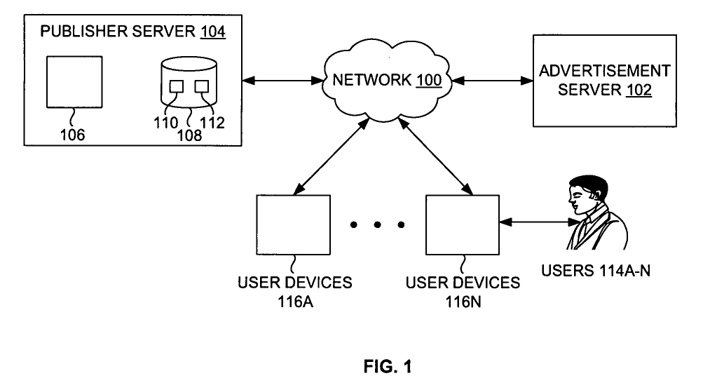

The embodiments herein achieve this by providing a method of overlaying a graphical advertisement on an image. Referring now to the drawings, and more particularly to FIGS. 1 through 11, where similar reference characters denote corresponding features consistently throughout the figures, there are shown preferred embodiments.

FIG. 1 illustrates a system view of an advertisement server 102 communicating with a publisher server 104 and users 114A-N through a network 100 according to an embodiment herein. The publisher server 104 includes an overlaying script 106, and a database 108. The database 108 includes electronic documents 110 and images 112. The advertisement server 102 may contain list of the advertisements associated with images 112 that are to be overlaid on the images 112 in the electronic document 110. The advertisement server 102 may manage the advertisements. In one embodiment, the advertisement server 102 may choose an advertisement. In another embodiment, the advertisement server 102 may generate the advertisements.

The advertisement includes a size, a shape and/or opacity defining the nature of the advertisement which the publisher server 104 wishes to place. The advertisement is determined based on size of the image, a relative position in the document and/or the user configuration instructions. In one embodiment, the advertisement is selected based on contextual information associated with the electronic document. The advertisement refers to the object in the images 112. The publisher server 104 publishes the advertisements in the electronic document 110 (e.g., a web page). In one embodiment, the publisher server 104 identifies the sections in the images 112 and adds the contextual information. The publisher server 104 creates a hot map to identify a person or an object or a location in the image 112. The advertisements may include an image, a text, a graphic, a video or a combination of all and contextual information associated with the image 112, the graphic, the video and/or the text.

In one embodiment, the advertisements are generated automatically by the overlaying script 106. The overlaying script 106 may reside on the electronic document 110. In another embodiment, the overlaying script 106 is overlaid for passing back information of the electronic document 110 and the image information of the images 112. The electronic document information and the image information are identified by a URL to the advertisement server 102.

For example, the image information may include location information of the image and/or nature of the image (e.g., EXIF data in the image). For example, identifying a device (e.g., the brand and/or make of camera used for taking the image, etc.). The publisher server 102 place (not theirs) advertisements on the images 112 in the electronic document 110. The database 108 sends information such as the hot map, the objects, the image information etc. to the advertisement server 102.

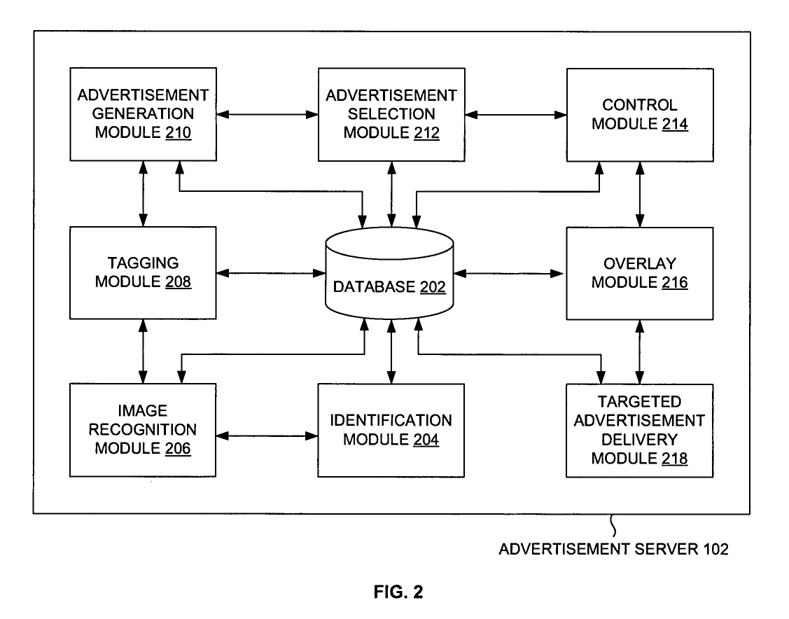

In one embodiment, when a user visits the electronic document with the help of the user devices 116A-N (e.g., an internet browser), the overlaying script 106 is invoked automatically from the publisher server 104. In one embodiment, an optimum image is determined by an image recognition engine (e.g., an image recognition module 206 of FIG. 2) based on at least one object in the image identified by the image recognition engine. The object information associated with the object of the image is processed to obtain an object identifier.

The objects are matched with a database of advertisements based on the object identifier to obtain the contextual advertisement. In another embodiment, the optimum image is determined based on the object information obtained from a tagging module 208 of FIG. 2. The object information is automatically generated by the image recognition engine based on at least one characteristic of the image. The characteristic of the image is determined by using an optimal character recognition technique.

FIG. 2 illustrates an exploded view of the advertisement server 102 of FIG. 1 having a database 202, an identification module 204, an image recognition module 206, a tagging module 208, an advertisement generation module 210, an advertisement selection module 212, a control module 214, an overlay module 216, and a targeted advertisement delivery module 218 according to an embodiment herein. The advertisement server 102 may receive URL data from overlaying script 108 to match it with the relevant advertisements. In addition, the advertisement server 102 relays back the advertisement to the overlaying script 106 and then overlays the advertisement on the image 112.

The advertisement server 102 automatically identifies an optimum image amongst many other images to overlay the advertisements on top of the images. The database 202 may store/contain the contextual information associated with the advertisement, and the electronic documents 110 where the overlaying script 106 exists. The identification module 204 identifies the optimum image (e.g., the image 112 of FIG. 1) available on the electronic document 110 for the relevant advertisement. In one embodiment, the best-fit image (e.g., the optimum image) may be automatically identified amongst the rest on the electronic document 110 with no-interaction between the content creator and the publisher server 104. In addition, the identification module 204 matches the relevant advertisement to relay back the advertisement to the overlaying script 106.

The image recognition module 206 identifies the images 112 based on shapes, colors, objects, places, activities, or a ready text. In addition, the image recognition module 206 identifies characters in the images 112. The tagging module 208 communicates with the image recognition module 206 to label (e.g., hot map) certain sections (e.g., objects) of the images 112 on the electronic document 110. In another embodiment, the advertisement server 102 sends information to the tagging module 208 (in case the publisher server 104 has not “hot mapped” on the image 112), which then utilizes it to hot-map on the images 112. The advertisement generation module 210 generates the advertisement on the images 112 (which are hot-mapped) based on a nature of the document, a size of the image, a user viewing medium, a screen resolution and/or a user behavior.

The advertisement selection module 212 selects the optimum image 112 based on the advertisement generated. The control module 214 generates a set of instructions which enables the advertisement server 106 to control and configure the advertisement depending upon user's response (e.g., mouse events). In one embodiment, the advertisement behavior is set based on the publisher server 104 preferences. For example, the advertisement may react to certain mouse events which are configurable and controlled via the advertisement server 102. The overlay module 216 overlays advertisements on images 112 in the electronic document 110. The targeted advertisement delivery module 218 delivers the targeted advertisement (hot-mapped on images 112) in the electronic document 110.

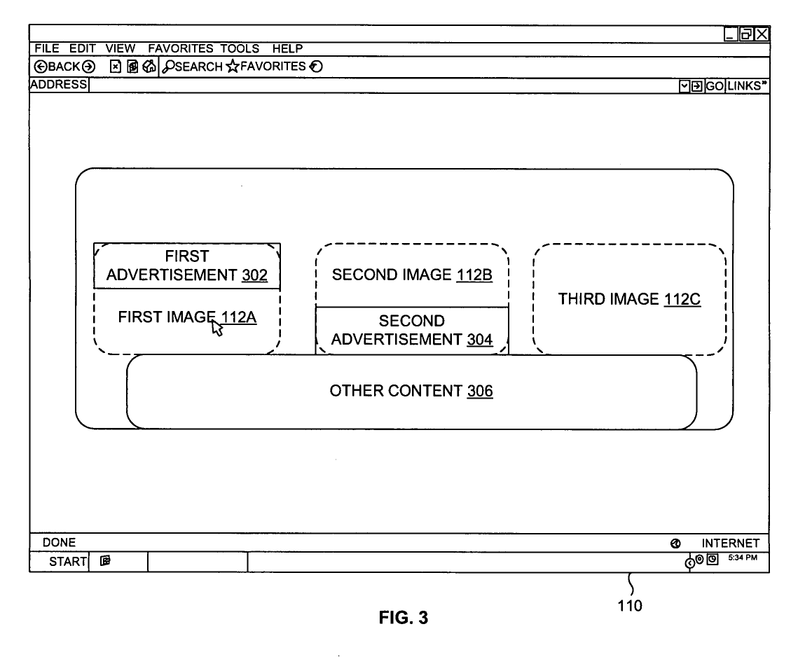

FIG. 3 is a user interface view of the electronic document 110 of the database 108 of FIG. 1 illustrating the advertisements overlaid on the images 112 having a first image 112A, a second image 112B, a third image 112C, a first advertisement 302, a second advertisement 304, and other content 306 according to an embodiment herein. The advertisements are generated based on at least one of a document, a size of the image, a user viewing medium, a screen resolution, recognizing objects in the image, facial recognition of persons in the image, location where the photo was taken and the user behavior. The graphic, the video, the image and/or the text may be transparent or translucent and appears in response to the user action.

The images 112A, 112B, and 112C may be a two dimensional picture (e.g., a photograph). In one embodiment, the advertisements 302 and 304 are overlaid on the first image 112A, and the second image 112B, (e.g., using the overlay module 216 of FIG. 2), and the third image 112C may be a contextual information generated based on user interactions. The first advertisement 302, and the second advertisement 304 overlaid on the images (e.g., the first image 112A and the second image 112B) are the relevant advertisements and fit appropriate to the first image 112A and the second image 112B. The advertisement is overlaid based on at least a size of said image, a location of said image in said electronic document, and a user configuration.

In one embodiment, an optimized advertisement is delivered based on the characteristic of the image 112. In one embodiment, the image 112 may have a black background, the advertisement may be transparent and with grey background. In another embodiment, opacity of the advertisement is based on the background color of the image. In yet another embodiment, the contextual advertisements are delivered on the images 112 based on the contextual information derived from the document containing the image 112.

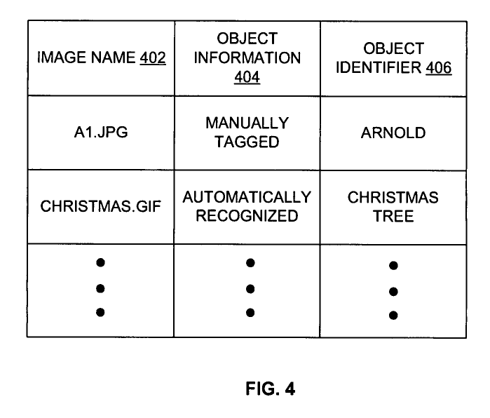

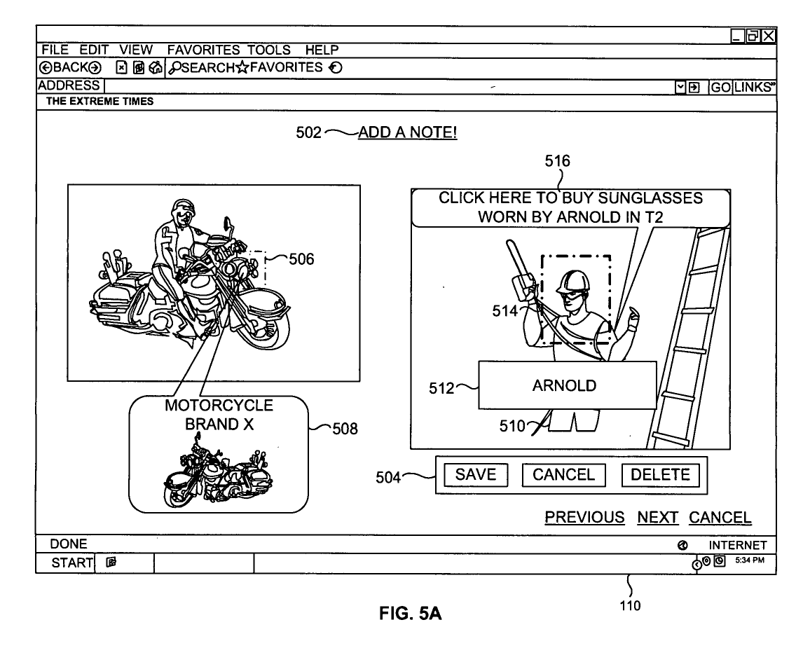

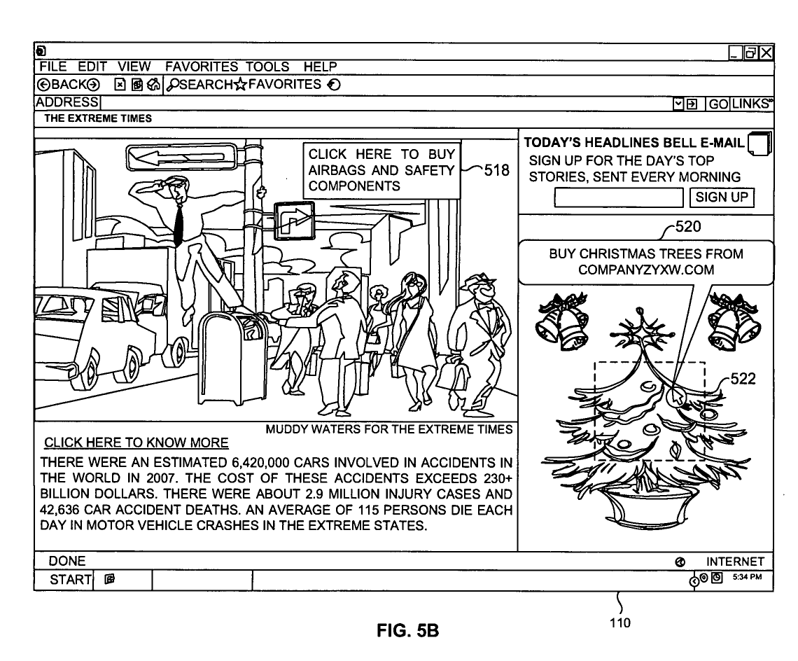

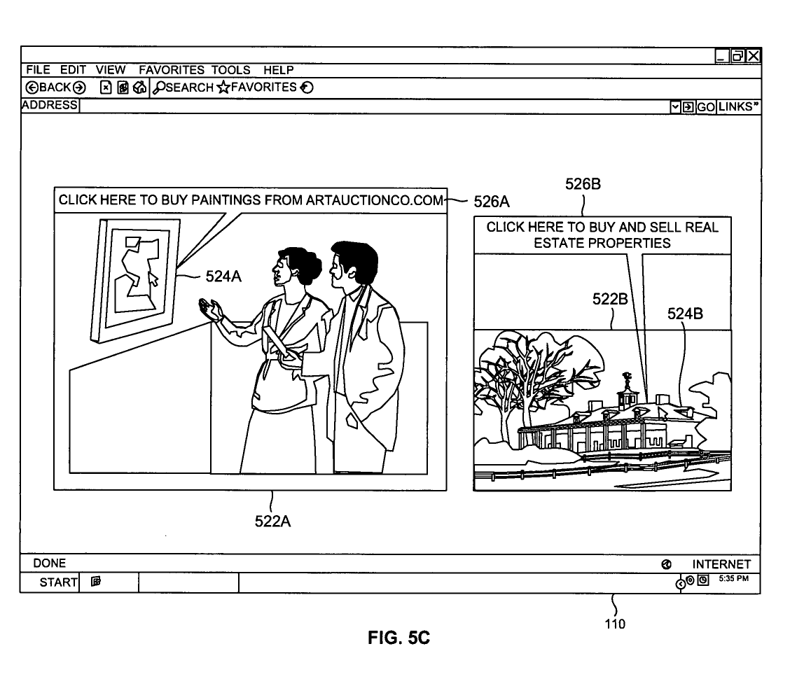

FIG. 4 illustrates a table view of a database of the tagging module 208 of FIG. 2 having an image name field 402, an object information field 404, and an object identifier field 406 according to an embodiment herein. The image name field 402 includes information of the image (e.g., A1.jpg and Christmas.gif). The object information field 404 includes information about object associated with the image 112 whether it is manually tagged or automatically recognized (as shown in FIG. 5A and FIG. 5B). In one embodiment, the object information associated with the object of the image is processed to obtain an object identifier. The object identifier field 406 includes the information of the images that are identified in the image 112 (e.g., Arnold of FIG. 5A and Christmas Tree of FIG. 5B). In one embodiment, the object identifier is obtained from a database populated by the tagging module 208.

FIG. 5A illustrates a user interface view of the electronic document 110 of the database 108 of the publisher server 104 of FIG. 1 of overlaying the advertisement on the images 112 by the publisher having a add a note option 502, options 504, a object 506, an image 508, an object 510, an object identifier 512, a section 514, and an a call out box 516 according to an embodiment herein. The overlaying script 106 executes and interacts with the advertisement server 102 which enables the publisher to add a note to the image 112 (e.g., using the add a note option 502). The publisher may also add and/or modify the advertisement format. The publisher may advertise in a normal format and/or may overlay the advertisement format.

The publisher may manually modify/edit each and every image. In an embodiment, the publisher may overlay the advertisement on top of the image (e.g., click here to buy this sunglass). The publisher may overlay the advertisement (e.g., a transparent) based on the user interaction. In one embodiment, the advertisements are delivered based on the objects identified by the object identifier. The publisher hot maps the image 112 to identify specific areas in the image (e.g., as shown in FIG. 5A). The advertisement server 102 determines the advertisement (e.g., real time determination) to be placed on a prominent image (e.g., the image 112 of FIG. 1). For example, the advertisement may be determined based on the text contained on the electronic document 110.

The publisher server 104 enables the publisher (e.g., advertisers) to identify and describe objects (e.g., identify motorcycle brand or the person(s) in an image 112 using the tagging module 208 of FIG. 2). For example, Arnold is an actor in an image published on the electronic document 110. The tagging module enables the publisher to save the object descriptions, cancel the object descriptions and/or delete the object descriptions (Arnold) by providing the option 504 (e.g., save option, a cancel option and/or a delete option).

The publisher server 104 allows the advertisement server 102 to know the details of the user (e.g., the location of the user, the nature of the browser, cookies, and/or personal details, etc.) when the user signups or subscribes for the services. The object 506 is identified and hot-mapped to identify specific area of the image. The hot map section 508 shows the advertisement of the image (e.g., Motorcycle Brand X) based on user interaction.

For example, a photographer takes photograph of a celebrity (e.g., Arnold) and publishes on the electronic document 110 and adds contextual information about the dress that the celebrity wore. When the user moves a cursor over the image, automatically a call out box appears (pop ups) at the top of the image (e.g., the hot map appears quoting “click here to buy the sunglasses worn by Arnold in T2). The call out box may be a drop down box or a dialog box (e.g., a cloud with an arrow at the bottom) which includes comments for preview. In addition, the advertisement server 102 generates hyperlinks automatically and enables the user to view more information/details of the celebrity and wears.

FIG. 5B is user interface views of the electronic document 110 of the database 108 of the publisher server 104 of FIG. 1 of overlaid advertisements on the images 112 as viewed by the users 114A-N according to an embodiment herein. In one embodiment, an advertisement is placed on any part of the electronic document 110. The advertisement is determined based on objects present in images 112 of the electronic document 110. The hot-maps are generated dynamically (e.g., section 522). The users 114A-N may view the overlaid advertisement which appears as a call out box 518 on top of the relevant image 112 when the user places a cursor on the images 112 which is hot-mapped (e.g., click here to but airbags and safety components as shown in FIG. 5B). The advertisement overlaps (e.g., superimposes) on the image 112. In another embodiment, the user 114A-N may view the advertisement on top of the image 112 when a call out box 520 appears (e.g., buy Christmas trees from companyzyxw.com).

With reference to FIG. 5B, FIG. 5C illustrates a user interface view of the electronic document 110 having images 522A and 522B, objects 524A and 524B, and call out boxes 526A and 526B according to an embodiment herein. The objects 524A (e.g., a painting) and 524B (e.g., a house) are identified in the images 522A and 522B. In one embodiment, the users 114A-N moves a cursor on the object 524A (e.g., the painting), the call out box 526A appears (e.g., click here to buy paintings from artauctionco.com).

In another embodiment, when the user moves a cursor on top of the object 524B (e.g., the house), the call out box 526B appears (e.g., “click here to buy and sell real estate properties”). In one embodiment, the objects 524A and 524B (e.g., the painting and the house) in the images 522A and 522B are identified (using the image recognition module 206 of FIG. 2) and the advertisement overlaid are delivered by the advertisement server 102 (e.g., using the targeted advertisement delivery module 218 of FIG. 2). In one embodiment, an appropriate advertisement is selected from the database 108 (e.g., using the advertisement selection module 212 of FIG. 2).

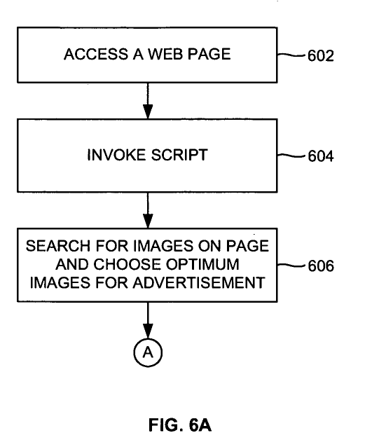

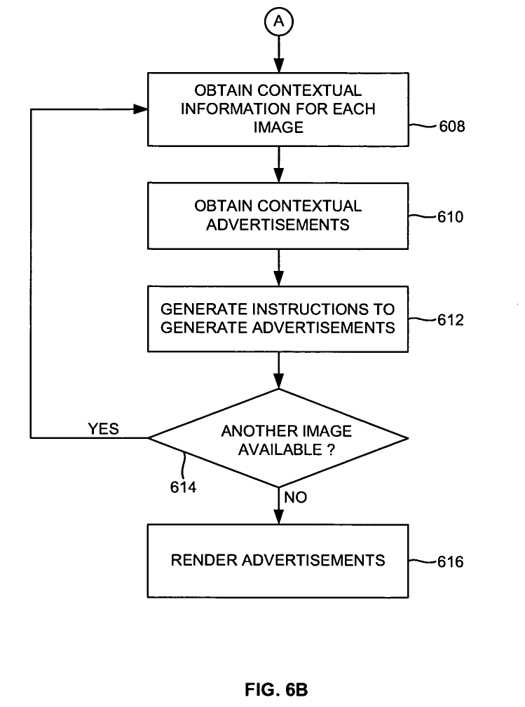

FIG. 6A-6B is a flow diagram illustrating a method of rendering advertisements on the images 112 in the electronic document 110 of the database 108 of the publisher server 104 of FIG. 1 according to an embodiment herein. In step 602, the webpage is accessed. In step 604, a script gets invoked on the webpage. In step 606, the images 112 are searched on the webpage and optimum images are chosen for the advertisement. In step 608, contextual information for each image is obtained. In step 610, contextual advertisements are obtained. In step 612, instructions are generated to generate the advertisements. In step 614, it is checked if another image is available. If another image is available (Yes), the steps from 608 are repeated, else (if No) advertisements are rendered in step 616.

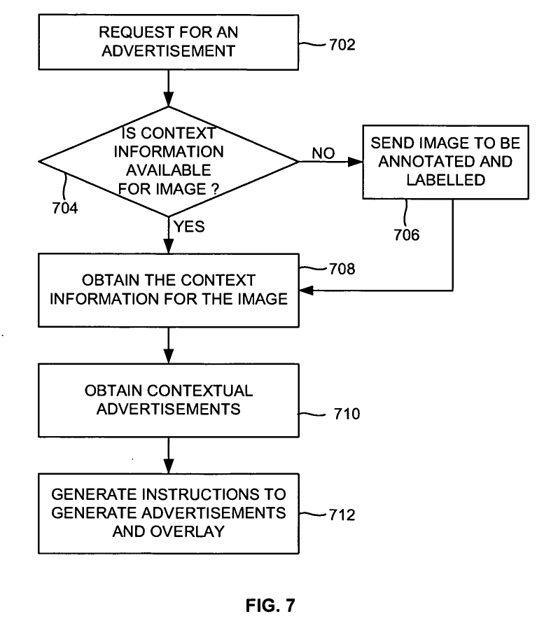

FIG. 7 is a flow diagram illustrating a method of generating instructions to generate and overlay advertisements on the images in the electronic document of the database 110 of the publisher server 104 of FIG. 1 according to an embodiment herein. In step 702, an advertisement is requested. In step 704, it is checked if context information is available for the image. If context information is available for image (Yes), the context information for the image is obtained in step 708, else (No) the image is sent to be annotated and labeled in step 706 and then the contextual information is obtained in step 708. In step 710, contextual advertisements are obtained. In step 712, instructions are generated to generate and overlay the advertisements.

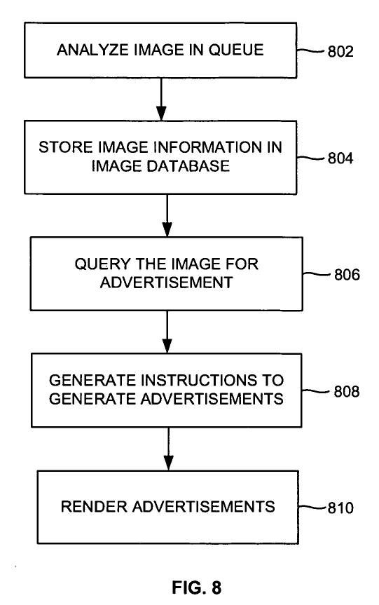

FIG. 8 is a flow diagram illustrating a method of image analysis for rendering advertisements on the images 112 in the electronic document 110 of the database 108 of the publisher server 104 of FIG. 1 according to an embodiment herein. In step 802, an image is analyzed in queue. In step 804, image information (e.g., includes an image size, a URL, a DOC URL, a hot map size/shapes, and/or co-ordinates etc.) are stored in image database. In one embodiment, the information stored in the image database is identified by an image recognition module 206 and the web crawler crawls the document containing contextual text. In step 806, the image is queried for the advertisement. In step 808, instructions are generated to generate the advertisements. In step 810, the advertisements are rendered on the electronic document.

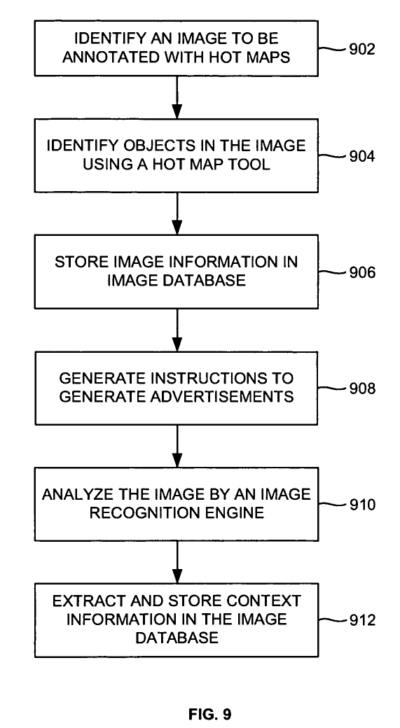

FIG. 9 is a flow diagram illustrating a method of storing contextual information in the database 108 of the publisher server 104 of FIG. 1 according to an embodiment herein. In step 902, an image to be annotated with hot maps is identified (by the publisher server 104 of FIG. 1). In step 904, objects in the image are identified by a hot map tool (e.g., using the tagging module 208 of FIG. 2). In step 906, image information (e.g., includes image size, shapes, co-ordinates, text of hot maps) is stored in image database. In step 908, instructions are generated to generate the advertisements. In step 910, the image is analyzed (e.g., hot map objects are validated with corresponding text) by the image recognition module 206 of FIG. 2. In step 912, context information is extracted and stored in the image database.

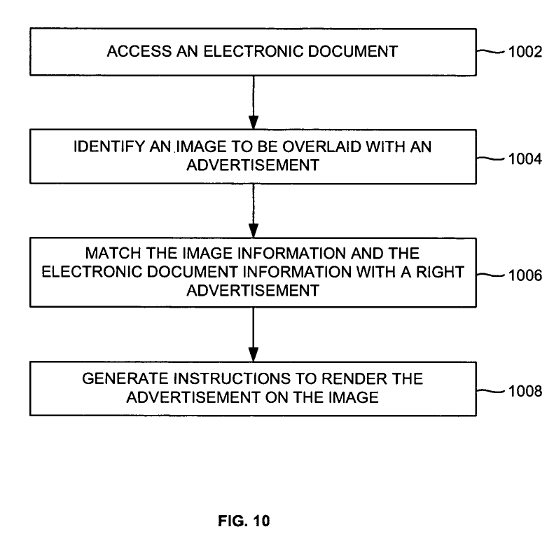

FIG. 10 is a flow diagram illustrating a method of rendering the advertisement on the image 112 according to an embodiment herein. In step 1002, an electronic document is access. In step 1004, an image to be overlaid with an advertisement is identified (e.g., using the identification module 204 of FIG. 2). In step 1006, the image information and the electronic document information are matched with a right advertisement (e.g., using the advertisement selection module 212). In step 1008, instructions are generated to render the advertisement on the image.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of an entirely hardware embodiment, an entirely software embodiment or an embodiment including both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

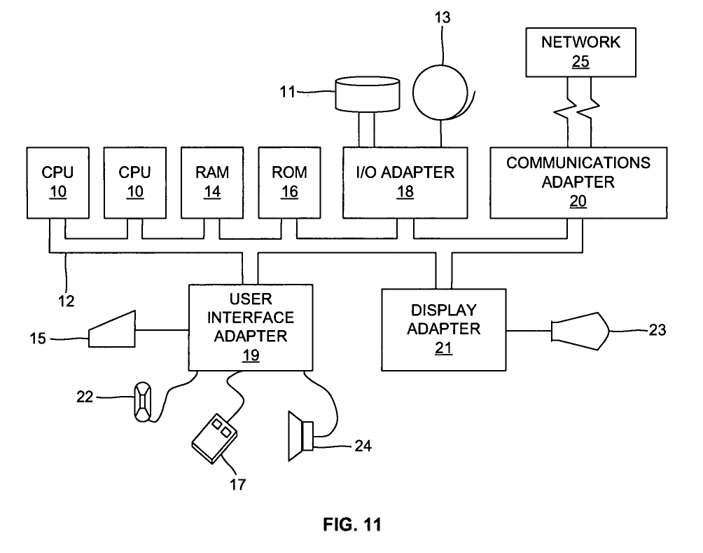

A representative hardware environment for practicing the embodiments herein is depicted in FIG. 11. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The embodiments herein provide a new and improved method for placing advertisements on the images. The advertisement server 102 contains list of the advertisements associated with an image (e.g., the image 112 of FIG. 1) having contextual information that are to be overlaid on the images 112 in an electronic document 110 and manages the advertisements. The advertisement server 102 determines the appropriate space for the advertisements which the publisher server 104 has identified. In addition, the advertisement server 106 may act as a single mechanism where the advertisers can signup for the services to provide advertisements. The advertisement server 102 automatically identifies an optimum image amongst many other images to overlay the advertisements on top of the images. The advertisements are automatically generated by overlaying a script which resides on the electronic document. The advertisements are dynamically generated based on the image recognition module 206 which identifies the objects, people and/or a ready text in the image.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method of overlaying an advertisement on an optimum image in an electronic document to be displayed on the internet, said electronic document comprising at least one image, said method comprising:
processing image parameters associated with said at least one image in said electronic document to obtain said optimum image; and
overlaying said advertisement on said optimum image, wherein said advertisement overlaps with said optimum image.

2. The method of claim 1, wherein said optimum image is determined by an image recognition engine based on at least one object in said image identified by said image recognition engine.

3. The method of claim 1, wherein said optimum image is determined based on object information obtained from a tagging module.

4. The method of claim 1, wherein said advertisement refers to said object.

5. The method of claim 1, wherein said advertisement is selected based on contextual information associated with said electronic document.

6. The method of claim 1, wherein said advertisement comprises any of a graphic, a video, and a text.

7. The method of claim 1, wherein said advertisement appears in response to a user action.

8. The method of claim 1, wherein an opacity of said advertisement is based on a background color of said optimum image.

9. The method of claim 1, wherein said advertisement is overlaid on said optimum image based on at least one of a size of said optimum image, a location of said optimum image in said electronic document, and a user configuration.

10. A method of placing a contextual advertisement obtained from a database of advertisements on an electronic document to be displayed on the internet, said electronic document comprising at least one image, said image comprising at least one object, said method comprising:
processing object information associated with said object of said image to obtain an object identifier; and
matching said object with said database of advertisements based on said object identifier to obtain said contextual advertisement, wherein said contextual advertisement is rendered on said electronic document.

11. The method of claim 10, wherein said object information is automatically generated by an image recognition engine based on at least one characteristic of said image.

12. The method of claim 10, wherein said object identifier is obtained from a database populated by a tagging module.

13. The method of claim 10, wherein said contextual advertisement is interlaced with said image so as to overlap with said image.

14. The method of claim 13, wherein said contextual advertisement refers to said object.

15. A method of determining a contextual advertisement obtained from a database of advertisements to be overlaid on an optimum image in an electronic document to be displayed on the internet, said electronic document comprising at least one image, said image comprising at least one object, said method comprising:
processing object information associated with said object, wherein said object information is obtained from a tagging module, wherein said optimum image is determined based on said object information; and
determining said contextual advertisement based on said object information, wherein said contextual advertisement is overlaid on said optimum image, wherein said contextual advertisement refers to said object.

16. The method of claim 15, wherein said contextual advertisement comprises any of a graphic, a video, and a text.

17. The method of claim 15, wherein said contextual advertisement is selected based on contextual information associated with said electronic document.

18. The method of claim 16, wherein said contextual advertisement appears in response to a user action.

19. The method of claim 15, wherein an opacity of said contextual advertisement is based on a background color of said image.

20. The method of claim 15, wherein said contextual advertisement is overlaid based on any of a size of said image, a location of said image in said electronic document, and a user configuration.
